(19) United States
(12) Patent Application Publication
(10) Pub. No.: US 2009/0159528 A1
(43) Pub. Date: Jun. 25, 2009

(54) Flow Divider and Separation System

(76) Inventors: Bernt Bjerkreim, Vestby (NO); Karl Olav Haram, Oslo (NO); Per Salater, Oslo (NO)

Correspondence Address: WENDEROTH, LIND & PONACK, L.L.P., 1030 15th Street, N.W.,, Suite 400 East, Washington, DC, 20005-1503, US

(21) Appl. No.: 12/084,792

(22) PCT Filed: Nov. 10, 2006
(86) PCT No.: PCT/NO2006/000408

§ 371 Date: Oct. 30, 2008

(30) Foreign Application Priority Data
Nov. 11, 2005 (NO) 20055356

(51) Int. Cl. B01D 19/00; B01D 17/00

(52) U.S. Cl. 210/513; 96/206

(57) ABSTRACT

The present invention relates to a flow divider (1) promoting separation, said flow divider (1) comprising an inlet (2), at least one dividing fin (3), and two or more outlets (4, 5). According to the present invention a pipeline (7) leading to the inlet (2) is sufficiently long to promote at least a degree of separation of a fluid that is carried through the pipeline (7) and that initially is mixed (6), the lighter constituents flowing through a top section of the pipeline (7), and the heavier constituents flowing through a bottom section of the pipeline (7), wherein the at least one dividing fin (3) is/are arranged either vertically and/or horizontally in order to divide the flow into two or more smaller flow streams downstream of the flow divider (1).

The present invention relates to a flow divider according to the preamble of claim 1.

Modern oil and gas production increasingly relies on installations wherein the collection, separation, boosting, and transport of production fluids takes place. These process plants may comprise a wide range of equipment, such as number of multi or single phase pumps and/or compressors, multi or single stage pumps or compressors, and/or other kinds of equipment that are arranged in parallel in order to transport and/or process the production fluids from the source to some remote location, whereas this parallel configuration is referred to as parallel trains. Before the production fluids reach the parallel trains, the production fluids are collected into larger pipes that lead to the trains. Before the production fluids enter the boosting equipment, the flow of production fluids must be divided equally between the trains. If both pumps and compressors are used in parallel, the production fluid must typically be feed into separation equipment, heat exchangers etc. in order to separate the liquid phase and the gas phase. In this case the gas phase is fed into one or more compressors and the liquid phase is fed into one or more pumps, wherein the pressure of the gas and liquid phases are considerably increased before they are transported through pipelines to some remote location. Regardless if separators are necessary or not, the flow of production fluids must be divided as evenly as possible before the flow reaches the boosting trains, in order to utilize the maximum rated power of boosting trains and ensure equal distribution of inhibitors.

The conventional solution is to feed the collected production fluids into some sort of manifold, wherein the fluids are mixed and distributed into the two or more parallel trains. However, this solution may result in an uneven and fluctuating distribution of the production fluids and possible inhibitors, and as a consequence the separation equipment, heat exchangers, pumps and especially compressors have to be dimensioned for sufficient capacity to deal with temporary fluctuations and peaks. This over-dimensioning of equipment results in increased costs and weight of the process plant, and by ensuring a more even and constant distribution of production fluids to the parallel trains would result in significant savings and improve distribution of inhibitors. Also, the violent mixing of the production fluid right before it enters the separation equipment results in longer dwell times in the separators and a need for larger separation equipment, these factors also adding to the cost.

The present invention according to claim 1 provides a flow divider that divides the fluid flow more evenly and with less mixing of the fluids than conventional solutions.

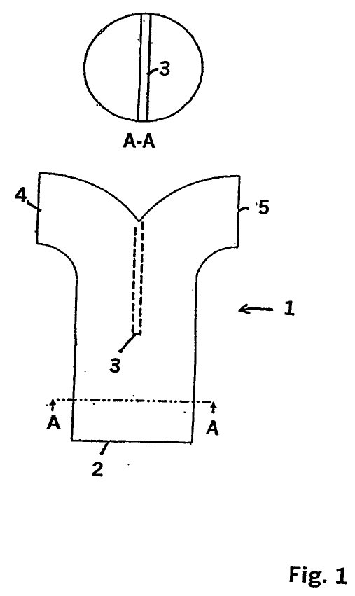

FIG. 1 shows one embodiment of the flow divider according to the present invention,

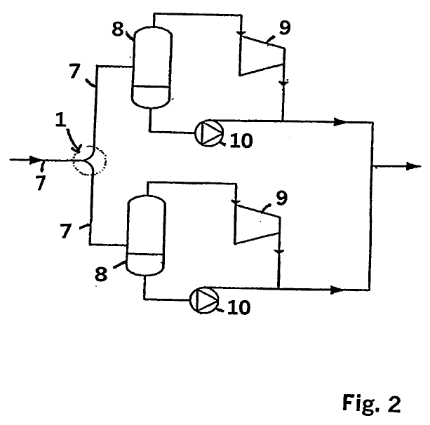

FIG. 2 shows the flow divider according to the present invention used in an application comprising two trains, and

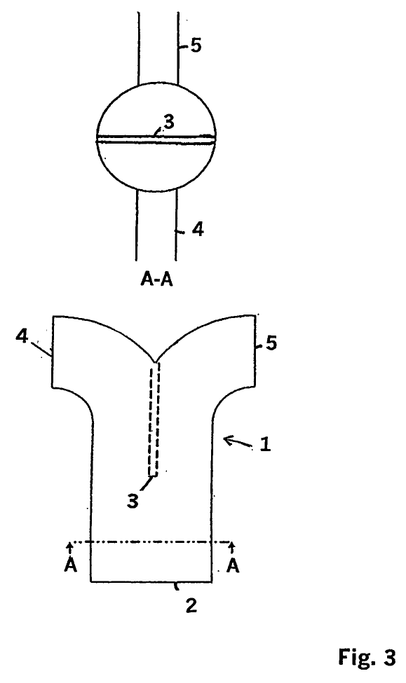

FIG. 3 shows another embodiment of the flow divider according to the present invention.

FIG. 1 shows a flow divider 1 according to the present invention, the flow divider 1 comprising an inlet 2, a dividing fin 3, and outlets 4, 5. The production fluid flow 6 entering the flow divider 1 through the inlet 2 has been lead through a production fluid collection and transport pipeline 7. Each of the outlets 4, 5 lead to downstream equipment. FIG. 2 shows an embodiment of the present invention where a scrubber 8 receives the divided fluid and separates it, before the gas is fed into a compressor 9 and the liquid is fed into a pump 10.

It is an important feature that the fluid is equally distributed over the cross section upstream of the flow divider, e.g. bends and restrictions right upstream of the flow divider should be avoided.

According to one embodiment of the present invention, it may be of importance that the production fluid 6 carried in the production pipeline 7 to the flow divider 1 is stirred to the least degree possible. Tests have shown that a largely undisrupted flow of production fluid over longer stretches through a pipeline, results in a large degree of separation of the production fluid already in the pipeline. If this multi-phase flow is allowed to reach the separators 8 upstream the boosting equipment 9, 10, without being disrupted by various restrictions along the pipeline 7 and pressure equalizing manifolds, the separators 8 will have an easier job completing the separation of the production fluid 6, thereby increasing the efficiency of the boosting process.

The flow divider 1 according to the present invention contributes significantly to this end. According to one preferred embodiment of the present invention, the dividing fin 3 is arranged vertically by the inlet 2 of the flow divider 1. The shape and design of the inlet 2, dividing fin 3, and outlets 4, 5, may be optimized in regard to ensuring that the layered and partly pre-separated production fluid 6 may continue calmly and undisrupted on its way to the separators 8 and boosting equipment 9, 10.

If the flow has to be divided into more than two separate streams, further flow dividers may be arranged further downstream of the first flow divider 1.

If the pipeline 7 collects production fluids from more than one well, as is often the case, this collection may take place somewhere upstream of the flow dividers, ensuring that the distance between the collection point and the flow divider 1 is sufficient to promote an even distribution over the cross section area of the inlet 2 and possibly a predetermined degree of separation or layering in the pipeline 7 before the layered production fluid enters the flow divider 1, separation equipment 8, or a pump or compressor. It is understood that several factors can help determine how long the pipeline 7 must be in order to promote an even distribution over the cross section area and possibly separation, i.e. the physical properties of the production fluids, flow rate, dimensions of the pipeline 7, and the degree of separation that is preferred.

According to another preferred embodiment of the present invention, it is also possible to arrange the dividing fins 3 horizontally at one or more predetermined levels in the flow divider 1. This is shown in FIG. 3. Since the length and configuration of the pipeline 7 already has encouraged a certain degree; of separation, the horizontal fins 3 may be arranged in, or at least very close to the interface(s) between the various layers of the layered production fluid. The flow divider 1 will thereby in itself constitute a separator, wherein the fluids separated from e.g. the top half of the pipeline mainly comprises gas with perhaps some oil content, and the fluids separated from the bottom half mainly comprises oil and water. The two streams can be fed to two different separation equipments, one separating out the oil from the gas, the other separating the oil and water.

It is understood that the flow divider 1 according to the present invention also may be used for single phase flow. In a one phase flow, the fin may form a cross dividing the flow into four. However, the full potential of the present invention is reached when the separation of the production fluid flow in the pipeline 7 before the flow divider 1 is allowed to commence, and preferably has reached a stable layered multiphase flow with distinct interfaces between the various phases.

1. A flow divider (1) promoting equal distribution between parallel trains and separation, said flow divider (1) comprising an inlet (2), at least one dividing fin (3), and two or more outlets (4, 5),
characterized in that
a pipeline (7) leading to the inlet (2) is sufficiently long to promote at least a degree of separation of a fluid that is carried through the pipeline (7) and an equal fluid distribution over the cross section area of the pipeline (7), the lighter constituents flowing through a top section of the pipeline (7), and the heavier constituents flowing through a bottom section of the pipeline (7), wherein the at least one dividing fin (3) is/are arranged either vertically and/or horizontally in order to divide the flow into two or more smaller flow streams downstream of the flow divider (1).

2. Flow divider according to claim 1,
characterized in that
the pipeline (7) is sufficiently long to promote a stable layered multiphase flow through the inlet (2).

3. Flow divider according to claim 1 or 2,
characterized in that
the fin or fins (3) is/are arranged vertically in order to divide the flow into two or more smaller streams downstream of the flow divider (1).

4. Flow divider according to claim 1 or 2,
characterized in that
the flow divider (1) is arranged to divide the flow into two or more smaller stable layered multiphase flow streams downstream of the flow divider (1).

5. Flow divider according to claim 1,
characterized in that
the fin or fins (3) is/are arranged horizontally in order to separate the lighter constituents and the heavier constituents, and directing the divided and separated flow streams through the outlets (4, 5) to further process components.

6. Flow divider according to claim 1,
characterized in that
the fins (3) are arranged both vertically and horizontally in order to both separate and divide the lighter constituents and the heavier constituents, through the outlets (4, 5), and into at least four separated downstream flow streams that each are directed onto further process components.
